(19) United States
(12) Patent Application Publication
(10) Pub. No.: US 2010/0220115 A1
(43) Pub. Date: Sep. 2, 2010

(54) METHOD FOR DRIVING PLASMA DISPLAY PANEL, AND PLASMA DISPLAY DEVICE

(76) Inventors: Tetsuya Sakamoto, Kanagawa (JP); Takashi Sasaki, Kanagawa (JP); Akihiro Takagi, Saitama (JP)

Correspondence Address: MILES & STOCKBRIDGE PC, 1751 PINNACLE DRIVE, SUITE 500, MCLEAN, VA, 22102-3833, US

(21) Appl. No.: 12/680,900

(22) PCT Filed: Dec. 17, 2007
(86) PCT No.: PCT/JP2007/001418

§ 371 Date: May 11, 2010

(51) Int. Cl. G09G 5/10; G09G 3/28

(52) U.S. Cl. 345/690; 345/60

(57) ABSTRACT

A plasma display device has a plasma display panel (PDP) and a driver unit driving the PDP. One field for displaying one screen of the PDP is made up of a plurality of subfields having a reset period and an address period. At least one of the plurality of subfields is a subfield for low luminance with number of times of sustain discharge being set to 0 (zero) and a voltage between a scan electrode and a sustain electrode during the address period being set smaller than a firing voltage between the scan electrode and the sustain electrode. The driver unit applies between the scan electrodes and the sustain electrodes a voltage smaller than the firing voltage between the scan electrodes and the sustain electrodes in a reset period of a subfield subsequent to the subfield for low luminance. As a result, luminance when reproducing black can be lowered.

### TECHNICAL FIELD

The present invention relates to a method of driving a plasma display panel and a plasma display device.

### BACKGROUND ART

A plasma display panel (PDP) is formed of two glass plates adhered to each other and displays an image by generating a discharge light in a space formed between the glass plates. Cells corresponding to pixels in an image are self-luminescence type, and phosphors which emit red, green and blue visible lights under an ultraviolet ray generated by discharge are applied to the cells.

In a typical PDP, a field for displaying one screen is made up of a plurality of subfields so as to display an image with multiple gradations. For example, a PDP having a three-electrode structure displays an image by generating a sustain discharge between an X electrode and a Y electrode in a sustain period. A cell generating the sustain discharge (cell to be lighted) is selected for example by generating an address discharge between the Y electrode and an address electrode and between the Y electrode and the X electrode in an address period. Further, before the address period, a reset period for storing wall charges for generating the address discharge exists.

In late years, there is suggested a PDP in which, for improving display gradations of low luminance, a field for displaying one screen is made up of a subfield in which the sustain period is omitted and subfields in which the sustain period is provided. Moreover, there is suggested a PDP in which, for improving display gradations of low luminance, the address discharge is generated only between the Y electrode and the address electrode and is not generated between the Y electrode and the X electrode in the address period of the subfield in which the sustain period is omitted (see, for example, Patent Document 1).

Patent Document 1: Japanese Unexamined Patent Application Publication No. 2005-157064

### DISCLOSURE OF THE INVENTION

### Problems to be Solved by the Invention

In a typical PDP, there is generated a visible light that is unnecessary for displaying an image (visible light that is fundamentally unnecessary) by the discharge generated in the reset period. When the luminance of this visible light is high, luminance when reproducing black (black luminance) and luminance when expressing low luminance become high, and image quality decreases. Incidentally, in the PDP of Patent Document 1, there is also generated a visible light that is unnecessary for displaying an image (visible light that is fundamentally unnecessary) by the discharge generated in the reset period.

A proposition of the present invention is to improve image quality when displaying a low luminance image by lowering the luminance when reproducing black (black luminance) or lowering the luminance when expressing low luminance.

### Means for Solving the Problems

A plasma display device has a plasma display panel (PDP) having a sustain electrode, a scan electrode, an address electrode and a plurality of cells which emit a light by a discharge, and a driver unit driving the PDP. One field for displaying one screen of the PDP is made up of a plurality of subfields having a reset period and an address period. In addition, at least one of the plurality of subfields is a subfield for low luminance with the number of times of sustain discharge being set to 0 (zero) and a voltage between the scan electrode and the sustain electrode during the address period being set smaller than a first firing voltage which is a firing voltage between the scan electrode and the sustain electrode. In the reset period of a subfield subsequent to the subfield for low luminance, the driver unit applies between the scan electrode and the sustain electrode a voltage smaller than a second firing voltage which is a firing voltage between the scan electrode and the sustain electrode.

### Effects of the Invention

In the present invention, luminance when reproducing black (black luminance) can be lowered or luminance when expressing low luminance can be lowered, and image quality when displaying a low luminance image can be improved.

### BRIEF DESCRIPTION OF THE DRAWINGS

FIG. 1 is a view showing a PDP device in one embodiment.

FIG. 2 is a view showing a main part of the PDP shown in FIG. 1.

FIG. 3 is a diagram showing a structural example of a field for displaying an image of one screen.

FIG. 4 is a diagram showing an example of discharge operations in subfields shown in FIG. 3.

FIG. 5 is a diagram showing an overview of a circuit unit shown in FIG. 1.

FIG. 6 is a diagram showing an example of a circuit unit of a PDP device in another embodiment.

FIG. 7 is a diagram showing an example of discharge operations in subfields by the circuit unit shown in FIG. 6.

FIG. 8 is a diagram showing a modification example of the discharge operations shown in FIG. 4.

FIG. 9 is a diagram showing a modification example of the discharge operations shown in FIG. 7.

FIG. 10 is a diagram showing a modification example of the structure of the field shown in FIG. 3.

FIG. 11 is a diagram showing another modification example of the structure of the field shown in FIG. 3.

FIG. 12 is a diagram showing another modification example of the structure of the field shown in FIG. 3.

### BEST MODE FOR CARRYING OUT THE INVENTION

Hereinafter, embodiments of the present invention will be described using the drawings.

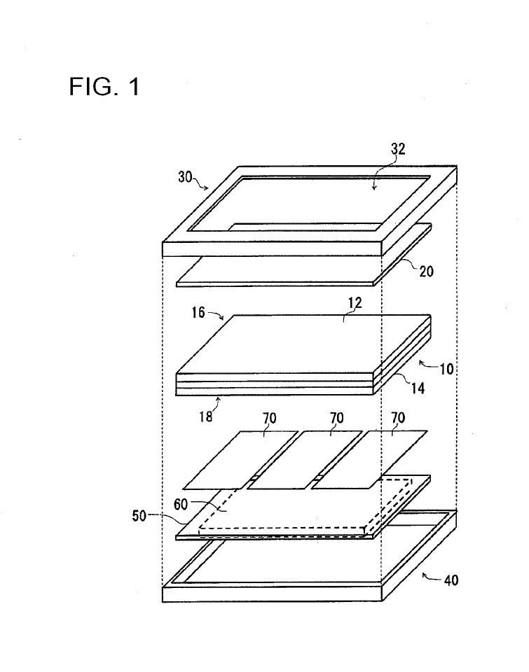

FIG. 1 illustrates an embodiment of the present invention. A plasma display device (hereinafter also referred to as a PDP device) has a plasma display panel 10 (hereinafter also referred to as PDP) having a quadrangle plate shape, an optical filter 20 provided on the side of an image display surface 16 (light output side) of the PDP 10, a front case 30 disposed on the side of the image display surface 16 of the PDP 10, a rear case 40 and a base chassis 50 disposed on the side of a rear face 18 of the PDP 10, a circuit unit 60 (driver unit) fixed to the side of the rear case 40 of the base chassis 50 for driving the PDP 10, and a double-faced adhesive sheet 70 for adhering the PDP 10 to the base chassis 50. The circuit unit 60 is made up of plural parts and therefore illustrated as a dashed line box in the diagram.

The PDP 10 is made up of a front plate part 12 forming the image display surface 16 and a back plate part 14 facing the front plate part 12. Not shown discharge spaces (cells) are formed between the front plate part 12 and the back plate part 14. The front plate part 12 and the back plate part 14 are formed of a glass plate for example. The optical filter 20 is adhered to a protection glass (not shown) fixed to an opening part 32 of the front case 30. Incidentally, the optical filter 20 may have a function to shield against electromagnetic waves. Further, the optical filter 20 may be adhered directly to the side of the image display surface 16 of the PDP 10 instead of the protection glass.

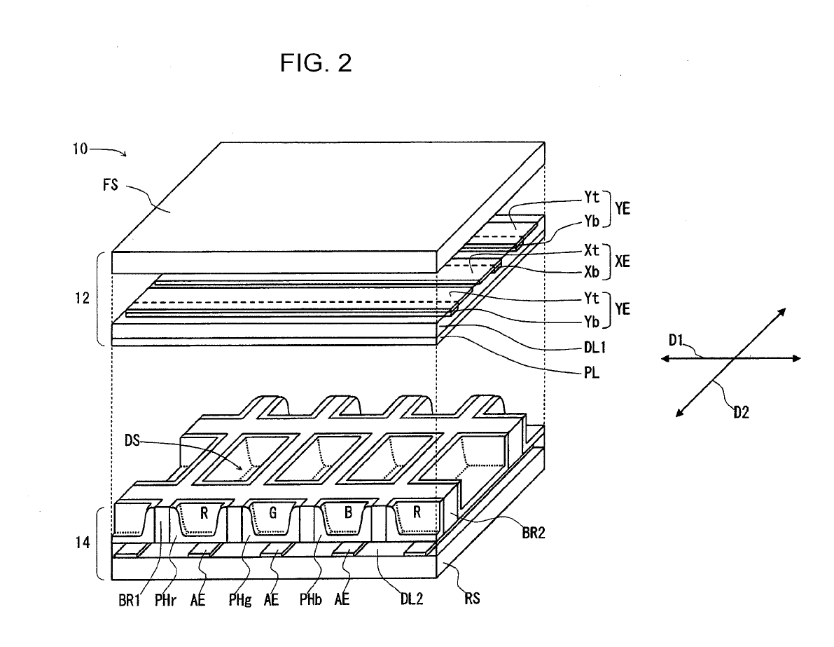

FIG. 2 shows details of a main part of the PDP 10 shown in FIG. 1. An arrow D1 in the diagram denotes a first direction D1, and an arrow D2 denotes a second direction D2 orthogonal to the first direction D1 in a plane parallel to the image display surface. As described above, discharge spaces DS are formed between the front plate part 12 and the back plate part 14 (more specifically, in a dent part of the back plate part 14).

The front plate part 12 has X electrodes XE (sustain electrodes) and Y electrodes YE (scan electrodes) formed in parallel along the first direction D1 on a glass base FS (on a lower side in the diagram) and formed alternately along the second direction D2. A discharge (sustain discharge) is generated repeatedly between an X electrode XE and a Y electrode YE which are paired. Note that the X electrode XE is made up of an X bus electrode Xb extending in the first direction D1 and an X transparent electrode Xt coupled to the X bus electrode Xb. Further, the Y electrode YE is made up of a Y bus electrode Yb extending in the first direction D1 and a Y transparent electrode Yt coupled to the Y bus electrode Xb.

Here, the X bus electrode Xb and the Y bus electrode Yb are opaque electrodes formed of a metal material or the like, and the X transparent electrode Xt and the Y transparent electrode Yt are transparent electrodes transmitting a visible light, which are formed of an ITO film or the like. Incidentally, the electrodes integrated with the bus electrodes Xb and Yb may be formed instead of the transparent electrodes Xt and Yt with the same material (metal material or the like) as the bus electrodes Xb and Yb . The electrodes Xb, Xt, Yb, Yt are covered with a dielectric layer DL1, and the surface of the dielectric layer DL1 is covered with a protective layer PL. For example, the protective layer PL is formed of an MgO film with a high emission characteristic of secondary electrons due to collision of positive ions, so that the discharge can be generated easily.

The back plate part 14 facing the front plate part 12 via the discharge spaces DS are structured such that a plurality of address electrodes AE extending in a direction orthogonal to the bus electrodes Xb, Yb (the second direction D2) are provided on a glass base RS. For example, the address electrodes AE are opaque electrodes formed of a metal material or the like. The address electrodes AE are covered with a dielectric layer DL2, and on the dielectric layer DL2, barrier ribs are formed in a lattice form, which are made up of first barrier ribs (barrier ribs) BR1 extending in the second direction D2 and second barrier ribs BR2 extending in the first direction D1. For example, a barrier rib BR1 is disposed at the position corresponding to the space between address electrodes AE adjacent to each other, and a barrier rib BR2 is disposed at the position corresponding to the space between a bus electrode Xb and a bus electrode Yb. Incidentally, without forming the barrier ribs BR2, stripe-shaped barrier ribs by the barrier ribs BR1 may be formed on the dielectric layer DL2.

The barrier ribs BR1, BR2 form side walls of the cells. Phosphors PHr, PHg, PHb emitting visible lights of red (R), green (G) and blue (B) as a result of being excited by an ultraviolet ray are applied on side faces of the barrier ribs BR1, BR2 and portions of the glass base RS surrounded by the barrier ribs BR1, BR2.

One pixel of the PDP 10 is made up of three cells emitting red, green and blue lights. Here, one cell (pixel with one color) is formed of a region surrounded by bus electrodes Xb, Yb and barrier ribs BR1. Specifically, in this embodiment, the cells are formed of regions surrounded by the barrier ribs BR1, BR2, and as described above, the side walls of the cells are formed of the barrier ribs BR1, BR2. Thus, the PDP 10 is structured by arranging cells for displaying an image in a matrix form, and alternately arranging several types of cells emitting lights of different colors from each other. Although not shown particularly, the cells formed along the bus electrodes Xb, Yb make up display lines.

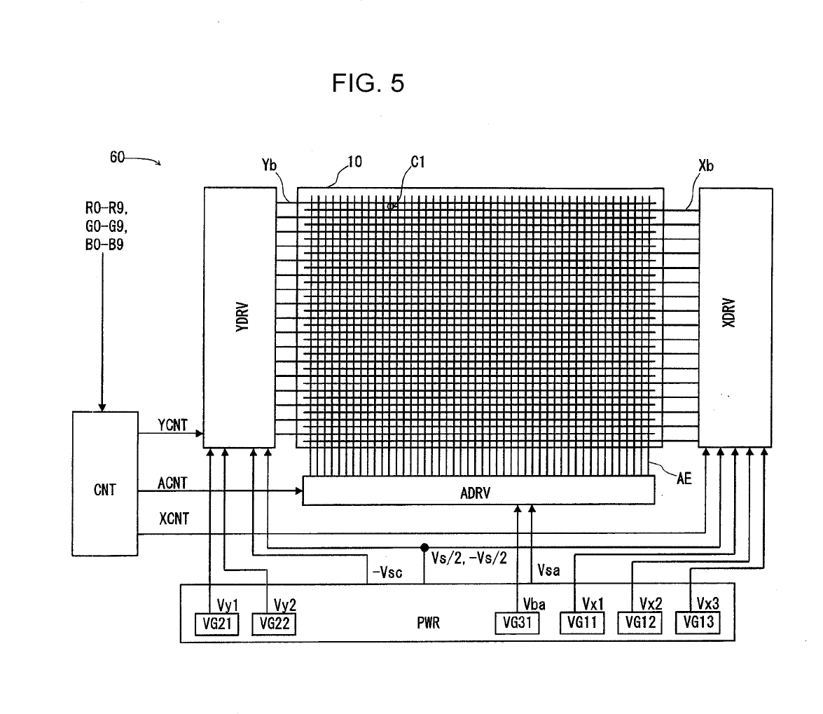

The PDP 10 is formed by adhering the front plate part 12 and the back plate part 14 so that the protective layer PL and the barrier ribs BR contact each other, and encapsulating a discharge gas such as Ne, Xe, or the like in the discharge spaces DS. The bus electrodes Xb, Yb and the address electrodes AE are coupled respectively to an X driver XDRV, a Y driver YDRV and an address driver ADRV which are shown in FIG. 5 described later.

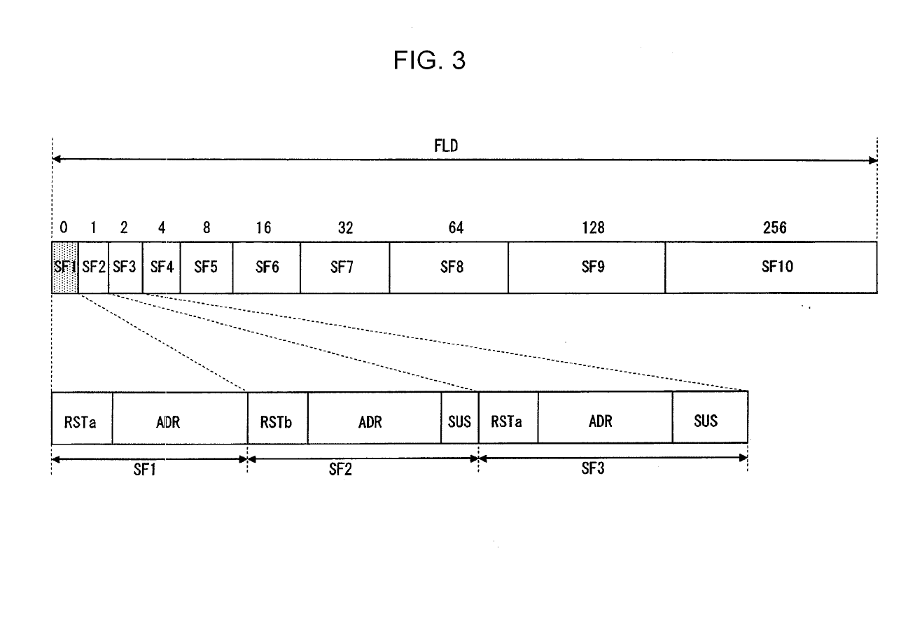

FIG. 3 shows a structural example of a field FLD for displaying an image of one screen. The hatched portion in the diagram indicates a subfield for low luminance (first subfield). One field FLD has a length of 1/60 second (approximately 16.7 ms) and is made up of 10 subfields SF (SF1-SF10), for example. In this example, the subfield SF1 is a subfield for low luminance having a reset period RSTa (second reset period) and an address period ADR.

Further, the subfield SF2 has a reset period RSTb (first reset period), an address period ADR and a sustain period SUS, and the subfields SF3-SF10 have a reset period RSTa, an address period ADR and a sustain period SUS. Hereinafter, the reset period RSTa (second reset period) is also referred to as a three-electrode reset period, and the reset period RSTb (first reset period) is also referred to as a two-electrode reset period. Further, the reset period RSTa and the reset period RSTb are also referred to as a reset period RST. That is, each subfield SF has a reset period RST and an address period ADR provided after the reset period RST.

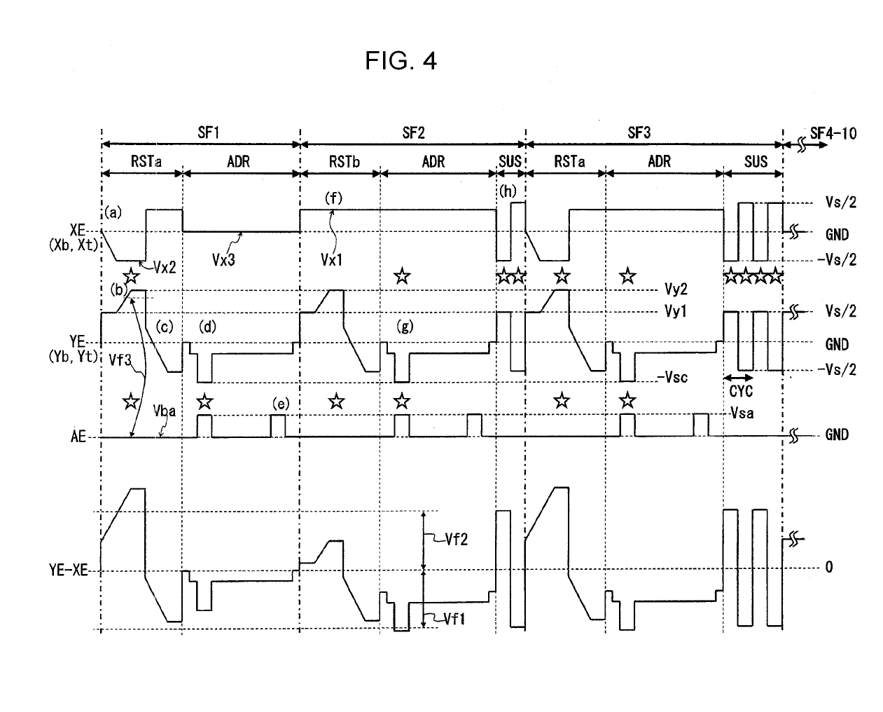

For example, the reset period RSTa is a period to adjust the amount of wall charges stored in each electrode XE, YE, AE, so as to match firing voltages (voltages at which generation of an address discharge in an address period ADR begins) of all the cells. Here, the wall charges are positive charges and negative charges stored in the surface of the protective layer PL, such as MgO shown in FIG. 2, in each cell for example. Further, the reset period RSTb is a period to adjust the amount of wall charges stored in each electrode YE, AE, so as to match firing voltages (voltages at which generation of an address discharge in an address period ADR begins) of all the cells. Details of the reset periods RSTa, RSTb will be explained with FIG. 4 described later.

The address period ADR is a period to select cells to be lighted for displaying an image. Particularly, the address period ADR of the subfields SF2-SF10 having a sustain period SUS is a period to select cells to be lighted in the sustain period SUS. The cells to be lighted in the sustain period SUS are selected by, for example, selectively generating an address discharge between the scan electrodes YE and the address electrodes AE in the address period as shown in FIG. 4 described later. The sustain period SUS is a period to generate a sustain discharge in a cell selected in the address period ADR.

The length of the sustain period SUS differs in each subfield SF and depends on the number of times of discharge (luminance) in the cell. Accordingly, changing a combination of subfields SF to be lighted enables to display an image with multiple gradations. In this example, the numbers of discharge cycles set in advance in the subfields SF1-SF10 are 0, 1, 2, 4, 8, 16, 32, 64, 128, 256, respectively. That is, the subfield SF1 for low luminance is a subfield SF in which the sustain discharge is not generated. As shown in FIG. 4 described later, a cell discharges twice (star symbols in the diagram) in one discharge cycle CYC.

FIG. 4 shows an example of discharge operations in the subfields SF shown in FIG. 3. A star symbol in the diagram denotes generation of a discharge. The lowest waveform (YE-XE) in the diagram indicates the voltage between a scan electrode YE and a sustain electrode XE. Further, voltages Vf1, Vf2, Vf3 indicate firing voltages between electrodes when wall charges are not stored in electrodes XE, YE, AE, for example. For example, the firing voltage Vf1 (first firing voltage) is a minimum voltage to generate a discharge between the scan electrode YE and the sustain electrode XE with the scan electrode YE being a cathode. The firing voltage Vf2 (second firing voltage) is a minimum voltage to generate a discharge between the scan electrode YE and the sustain electrode XE with the scan electrode YE being an anode. The firing voltage Vf3 (third firing voltage) is a minimum voltage to generate a discharge between the scan electrode YE and the address electrode AE with the scan electrode YE being an anode.

First, in the reset period RSTa of the subfield SF1 for low luminance, a negative voltage (slope pulse) gradually decreasing to a voltage Vx2 (second control voltage) is applied to a sustain electrode XE (a bus electrode Xb and a transparent electrode Xt) (FIG. 4(a)), a positive voltage is applied to a scan electrode YE (a bus electrode Yb and a transparent electrode Yt), and a voltage Vba (bias voltage) is applied to an address electrode AE. For example, the voltage Vx2 is a voltage lower than a voltage Vx1 (first control voltage) described later, and the voltage Vba is a voltage of a ground line GND (0 V). Incidentally, the voltage Vba may either be a positive voltage or a negative voltage.

Then the sustain electrode XE and the address electrode AE are sustained at the voltage Vx2 and the voltage Vba respectively, and a positive write voltage (waveform voltage, write slope pulse) increasing gradually from a voltage Vy1 to a voltage Vy2 (first voltage) is applied to the scan electrode YE (FIG. 4(b)). Here, the positive write voltage is a voltage which causes the voltage between the scan electrode YE and the sustain electrode XE to be at the firing voltage Vf2 or higher, and the voltage between the scan electrode YE and the address electrode AE to be at the firing voltage Vf3 or higher. That is, the voltage Vy2 (maximum voltage of a waveform voltage, first voltage) is a voltage which causes the voltage between the scan electrode YE and the address electrode AE to be at the firing voltage Vf3 or higher when the voltage Vba is applied to the address electrode AE. Further, in the example of the drawing, the voltage Vy1 is the same voltage as a voltage Vs/2 of a positive sustain pulse, which will be described later.

A voltage equal to or higher than the firing voltage Vf2 is applied between the scan electrode YE and the sustain electrode XE, and thus a reset discharge (weak discharge) occurs between the scan electrode YE and the sustain electrode XE. Further, a voltage equal to or higher than the firing voltage Vf3 is applied between the scan electrode YE and the address electrode AE, and thus a reset discharge (weak discharge) occurs between the scan electrode YE and the address electrode AE. This causes a positive wall charge, a negative wall charge and a positive wall charge to be stored in the electrodes XE, YE and AE respectively while suppressing luminescence of the cells. Thus, the three-electrode reset period RSTa is a period to generate the reset discharge between the scan electrode YE and the address electrode AE and between the scan electrode YE and the sustain electrode XE.

Next, a positive adjusting voltage is applied to the sustain electrode XE, a negative adjusting voltage (adjusting slope pulse) is applied to the scan electrode YE, and the address electrode AE is sustained at the voltage Vba (FIG. 4(c)). Accordingly, the amounts of the positive wall charge, the negative wall charge and the positive wall charge stored respectively in the sustain electrode XE, the scan electrode YE and the address electrode AE decrease, and wall charges of all the cells are adjusted. Incidentally, for example, the positive adjusting voltage is the same voltage as the voltage Vs/2, and the minimum value of the negative adjusting voltage is a voltage higher than a voltage −Vsc.

In the address period ADR of the subfield SF1 for low luminance, a voltage Vx3 (third control voltage) is applied to the sustain electrode XE, a scan pulse (negative scan pulse, voltage −Vsc) to be a cathode during an address discharge is applied to the scan electrode YE, and the address pulse (positive address pulse, voltage Vsa) to be an anode during an address discharge is applied to the address electrode AE corresponding to cells to be lighted (FIG. 4(d)). In the cells selected by the scan pulse and the address pulse, an address discharge occurs between the scan electrode YE and the address electrode AE. As a result, the cells selected for displaying an image emit a visible light by the address discharge between the scan electrode YE and the address electrode AE.

Here, the voltage Vx3 is a voltage which causes the voltage between the scan electrode YE and the sustain electrode XE to be smaller than the firing voltage Vf1 even when the voltage −Vsc is applied to the scan electrode YE, and is the voltage (0 V) of the ground line GND for example. Since the voltage between the scan electrode YE and the sustain electrode XE is smaller than the firing voltage Vf1, no discharge occurs between the scan electrode YE and the sustain electrode XE. Incidentally, since the subfield SF1 for low luminance has no sustain period SUS (no sustain discharge is generated), it is not necessary to generate an address discharge between the scan electrode YE and the sustain electrode XE.

Accordingly, the luminance of a visible light emitted by a discharge in the address period ADR can be lowered, and luminance when reproducing black (black luminance) can be lowered. Thus, the subfield SF1 is a subfield for low luminance in which the number of times of sustain discharge is set to 0 (zero) and the voltage between the scan electrode YE and the sustain electrode XE during the address period ADR is set smaller than the firing voltage Vf1.

Note that in FIG. 4 only the waveform of the scan electrode YE corresponding to one display line of interest is shown among the plurality of scan electrodes YE, and thus a second address pulse (FIG. 4(e)) shown on the waveform of the address electrode AE indicates that it is applied to select a discharge cell of another display line.

Operational waveforms in the reset period RSTb of the subfield SF2 subsequent to the subfield SF1 for low luminance are the same as those in the reset period RSTa described above except the voltage applied to the sustain electrode XE. That is, in the scan electrode YE and the address electrode AE, similarly to the above-described reset period RSTa, a negative wall charge and a positive wall charge are stored respectively, and thereafter the amounts of the respective stored negative wall charges and positive wall charges decrease, and the wall charges of all the cells are adjusted.

Incidentally, since no discharge occurs between the scan electrode YE and the sustain electrode XE in the address period ADR of the subfield SF1, the wall charge stored in the sustain electrode XE is kept in a state of being adjusted in the reset period RSTa of the subfield SF1. Accordingly, in the reset period RSTb of the subfield SF2 subsequent to the subfield SF1, it is not necessary to generate a reset discharge between the scan electrode YE and the sustain electrode XE for adjusting the wall charge stored in the sustain electrode XE.

Therefore, in the reset period RSTb, the voltage Vx1 (first control voltage) is applied to the sustain electrode XE (FIG. 4(f)). Here, the voltage Vx1 is a voltage which causes the voltage between the scan electrode YE and the sustain electrode XE to be smaller than the firing voltage Vf2. For example, the voltage Vx1 is a voltage higher than the voltage Vx2. In other words, as described above, the voltage Vx2 is a voltage lower than the voltage Vx1. Further, in the example of the diagram, the voltage Vx3 is a voltage lower than the voltage Vx1 and higher than the voltage Vx2.

Since the voltage between the scan electrode YE and the sustain electrode XE is smaller than the firing voltage Vf2, no discharge occurs between the scan electrode YE and the sustain electrode XE. Thus, the luminance of a visible light emitted by a discharge in the reset period RSTb can be made lower as compared to the luminance of a visible light emitted by a discharge in the reset period RSTa. That is, the luminance of a visible light that is unnecessary for displaying an image emitted by a discharge in the reset period RST (visible light that is fundamentally unnecessary) can be lowered. As a result, in this embodiment, the luminance when reproducing black (black luminance) can be lowered, and image quality when displaying a low luminance image can be improved.

Incidentally, as in the explanation regarding the reset period RSTa described above, a reset discharge (weak discharge) occurs between the scan electrode YE and the sustain electrode XE because the voltage equal to or higher than the firing voltage Vf2 is applied thereto. Thus, the reset period RSTb of the subfield SF2 subsequent to the subfield SF1 for low luminance is a two-electrode reset period RSTb to generate a reset discharge between the scan electrode YE and the address electrode AE and between the scan electrode YE and the sustain electrode XE.

Operational waveforms in the address period ADR of the subfield SF2 are the same as those in the address period ADR of the above-described subfield SF1 except the voltage applied to the sustain electrode XE. That is, in the address period ADR of the subfield SF2, the voltage Vx1 to be an anode during an address discharge is applied to the sustain electrode XE, the scan pulse to be a cathode during an address discharge is applied to the scan electrode YE, and the address pulse to be an anode during an address discharge is applied to the address electrode AE corresponding to cells to be lighted (FIG. 4(g)). In this embodiment, the sustain electrode XE is sustained at the voltage Vx1 applied to the sustain electrode XE in the reset period RSTb.

For example, the voltage Vx1 is set to a voltage which causes the voltage between the scan electrode YE and the sustain electrode XE to be larger than the firing voltage Vf1 when the voltage −Vsc is applied to the scan electrode YE. In the cells selected by the scan pulse and the address pulse, an address discharge occurs between the scan electrode YE and the address electrode AE, and with this discharge being a trigger, an address discharge occurs between the scan electrode YE and the sustain electrode XE. Accordingly, a negative wall charge and a positive wall charge are stored in the sustain electrode XE and the scan electrode YE respectively, and cells to be lighted in the sustain period SUS are selected.

The luminance of a visible light emitted by the address discharge in the address period ADR of the subfield SF2 is higher as compared to the luminance of a visible light emitted by the address discharge in the address period ADR of the subfield SF1 because the address discharge occurs between the scan electrode YE and the sustain electrode XE. In other words, the luminance of the visible light emitted by the address discharge in the address period ADR of the subfield SF1 for low luminance is lower as compared to the luminance of a visible light emitted by an address discharge in the address period ADR of the subfields SF2-SF10 having a sustain period SUS.

In the sustain period SUS of the subfield SF2, negative and positive sustain pulses (voltage −Vs/2 and voltage Vs/2) are applied to the sustain electrode XE and the scan electrode YE, respectively (FIG. 4(h)). Accordingly, a sustain discharge occurs between the sustain electrode XE and the scan electrode YE in cells selected in the address period ADR. Application of the sustain pulses with different polarities from each other to the sustain electrode XE and the scan electrode YE repeatedly (one cycle CYC in the subfield SF2, two cycles CYC in the subfield SF3) causes cells lighted in the sustain period SUS to be discharged repeatedly (sustain discharge). Thus, discharged states of the lighted cells are sustained.

Operational waveforms in the reset period RSTa and the address period ADR of the subfield SF3 are the same as those in the reset period RSTa of the subfield SF1 and the address period ADR of the subfield SF2, respectively. Further, operational waveforms in the sustain period SUS of the subfield SF3 are the same as those in the sustain period SUS of the subfield SF2 except the number of discharge cycles CYC. Further, operational waveforms in the subfields SF4-SF10 are the same as those in the subfield SF3 except the number of discharge cycles CYC. In short, the subfield SF2 is the subfield SF subsequent to the subfield SF1 for low luminance, and the subfields SF1, SF3-SF10 are other subfields SF.

As explained with FIG. 3 described above, two discharges are performed in one discharge cycle CYC. For example, the subfield SF7 is formed of 32 discharge cycles CYC, and 64 discharges are performed. Incidentally, in a cell not to be lighted, the wall charge for sustain discharge is not stored in the sustain electrode XE and the scan electrode YE as described above, and thus a discharge (erroneous discharge) does not occur even when the sustain pulse is applied.

FIG. 5 shows an overview of the circuit unit 60 shown in FIG. 1. The circuit unit 60 (driver unit) has a power supply unit PWR, an X driver XDRV (sustain electrode driver circuit), a Y driver YDRV (scan electrode driver circuit), an address driver ADRV (address electrode driver circuit) and a control unit CNT. The power supply unit PWR has a voltage generating unit VG11 (first control voltage generating unit) generating the voltage Vx1, a voltage generating unit VG12 generating the voltage Vx2, a voltage generating unit VG13 (third control voltage generating unit) generating the voltage Vx3, a voltage generating unit VG21 generating the voltage Vy1, a voltage generating unit VG22 (first voltage generating unit) generating the voltage Vy2 and a voltage generating unit VG11 (bias voltage generating unit) generating the voltage Vba. The power supply unit PWR supplies the power supply voltages Vy1, Vy2, −Vsc, Vs/2, −Vs/2, Vx1, Vx2, Vx3, Vsa, Vba, and so on to the drivers YDRV, XDRV, ADRV. Incidentally, the voltage generating units VG11-13, VG21-22, VG31 may be provided in the drivers XDRV, YDRV, ADRV, respectively.

The drivers XDRV, YDRV, ADRV operate as a driver circuit to drive the PDP10. For example, the drivers XDRV, YDRV, ADRV apply the respective voltages (the voltage Vx2, the waveform voltage increasing from the voltage Vy1 to the voltage Vy2, the voltage Vba, and so on) to the bus electrodes Xb, Yb and the address electrode AE, as shown in FIG. 4 described above.

The control unit CNT selects subfields to be used based on image data R0-9, G0-9, B0-9, and outputs control signals YCNT, XCNT, ACNT to the drivers YDRV, XDRV, ADRV. Then by selecting subfields to be used for every cell C1 forming a pixel, an image with multiple gradations is displayed. Incidentally, the image data R0-9, G0-9, B0-9 are data formed of 10 bits for displaying red, green blue, and are input sequentially to the control unit CNT from a not shown tuner unit or an external input.

As described above, in this embodiment, in the reset period RSTb of the subfield SF2 subsequent to the subfield SF1 for low luminance, the voltage between the scan electrode YE and the sustain electrode XE is controlled to be smaller than the firing voltage Vf2. It is controlled not to generate a reset discharge between the scan electrode YE and the sustain electrode XE. Since the voltage between the scan electrode YE and the sustain electrode XE is smaller than the firing voltage Vf2, no discharge occurs between the scan electrode YE and the sustain electrode XE. As a result, the luminance of a visible light that is unnecessary for displaying an image (visible light that is fundamentally unnecessary) by a discharge emitted in the reset period RST can be lowered. In short, in this embodiment, the luminance when reproducing black (black luminance) can be lowered, and deep rich black can be reproduced, and therefore, image quality when displaying a low luminance image can be improved.

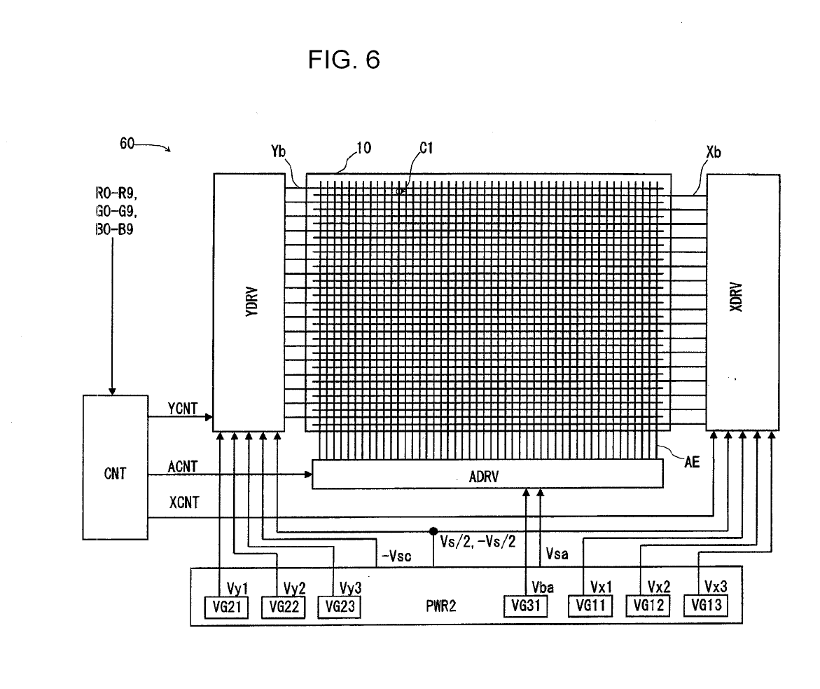

FIG. 6 shows an example of a circuit unit 60 of a PDP device in another embodiment. In this embodiment, a power supply unit PWR2 is provided instead of the power supply unit PWR shown in FIG. 5 described above. The other structure is the same as in FIG. 1 to FIG. 3. The same elements as those described in FIG. 1 to FIG. 3 are given the same reference symbols, and detailed descriptions thereof are omitted. The power supply unit PWR2 is structured by adding a voltage generating unit VG23 (second voltage generating unit) generating a voltage Vy3 (second voltage) lower than the voltage Vy2 to the power supply unit PWR shown in FIG. 5. The voltage Vy3 is supplied to the driver YDRV. Incidentally, the voltage generating units VG11-13, VG21-23, VG31 may be provided in the drivers XDRV, YDRV, ADRV, respectively.

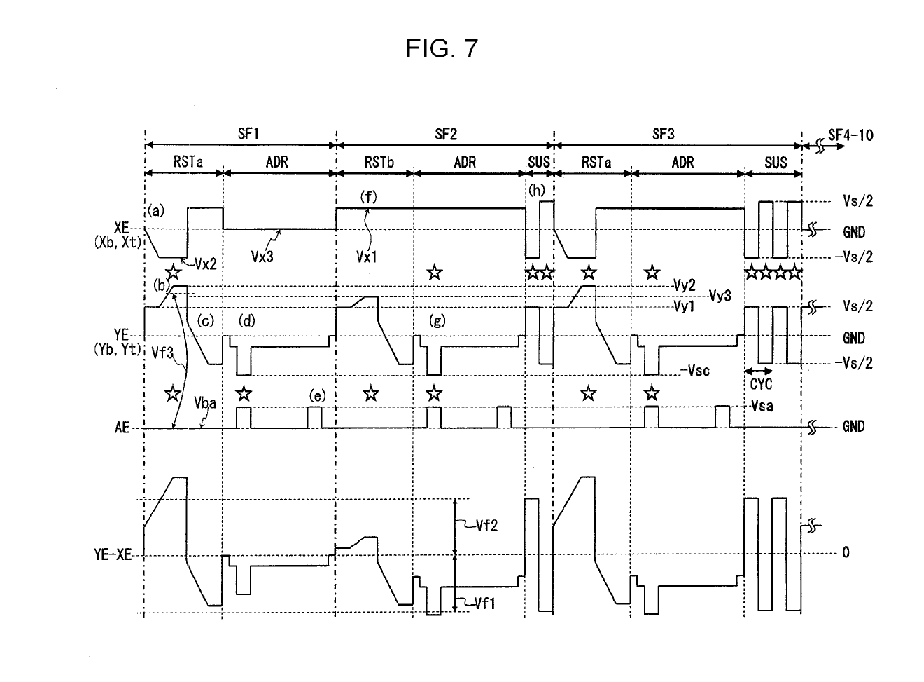

FIG. 7 shows an example of discharge operations in the subfields SF by the circuit unit 60 shown in FIG. 6. Detailed descriptions of the same operations as those in the above-described FIG. 4 are omitted. In this embodiment, waveforms in the two-electrode reset period RSTb are different from those in FIG. 4. More specifically, in the reset period RSTb, instead of the positive write voltage increasing gradually from the voltage Vy1 to the voltage Vy2 shown in FIG. 4, a positive write voltage (waveform voltage, write slope pulse) increasing gradually from the voltage Vy1 to the voltage Vy3 (second voltage) is applied to the scan electrode YE. The other waveforms are the same as those in FIG. 4. Star symbols in the diagram have the same meaning as in FIG. 4.

In the reset period RSTb of the subfield SF2 subsequent to the subfield SF1 for low luminance, when the positive write voltage increasing gradually from the voltage Vy1 to the voltage Vy3 is applied to the scan electrode YE, the voltages Vx1, Vba are applied to the sustain electrode XE and the address electrode AE, respectively. For example, the voltage Vy3 (second voltage) is a voltage lower than the voltage Vy2 (first voltage) and causes the voltage between the scan electrode YE and the address electrode AE to be lower than the firing voltage Vf3.

Here, in cells selected in the address period ADR of the subfield SF1, a positive wall charge and a negative wall charge are stored in the scan electrode YE and the address electrode AE, respectively. By superposing a voltage corresponding to this wall charge on the voltage between the scan electrode YE and the address electrode AE, the voltage between the scan electrode YE and the address electrode AE becomes equal to or higher than the firing voltage Vf3. As a result, in the cells selected in the address period ADR of the subfield SF1, a reset discharge occurs between the scan electrode YE and the address electrode AE. Thus, a negative wall charge and a positive wall charge are stored in the scan electrode YE and the address electrode AE, respectively.

On the other hand, in cells not selected in the address period ADR of the subfield SF1, a wall charge with a polarity that causes the voltage between the scan electrode YE and the address electrode AE to be large is not stored in the scan electrode YE and the address electrode AE. Therefore, the voltage between the scan electrode YE and the address electrode AE is lower than the firing voltage Vf3, and thus no reset discharge occurs between the scan electrode YE and the address electrode AE. That is, in the cells not selected in the address period ADR of the subfield SF1, the state of a wall charge adjusted in the reset period RST of the subfield SF1 is maintained. Incidentally, a voltage sufficiently lower than the firing voltage Vf2 is applied between the scan electrode YE and the sustain electrode XE, and thus no reset discharge occurs thereto irrespective of the states of cells.

After the positive write voltage is applied to the scan electrode YE, similarly to the reset period RSTb shown in FIG. 4 described above, the amounts of negative wall charges and positive wall charge stored respectively in the scan electrode YE and the address electrode AE decrease, and wall charges of all the cells are adjusted. In this manner, the reset period RST (two-electrode reset period RSTb) of the subfield SF2 is an on cell reset period in which a reset discharge is generated in cells selected in the address period ADR of the previous subfield SF1.

In the reset period RST of the subfields SF1, SF3-SF10, as explained with FIG. 4 described above, a voltage equal to or higher than the firing voltage Vf3 is applied between the scan electrode YE and the address electrode AE, and a voltage equal to or higher than the firing voltage Vf2 is applied between the scan electrode YE and the sustain electrode XE. That is, the reset period RST of the subfields SF1, SF3-SF10 (three-electrode reset period RSTa) is an all cell reset period to generate the reset discharge in all the cells irrespective of the states of cells. In other words, a reset period excluding the all cell reset period is the reset period RST of the subfield SF2 (two-electrode reset period RSTb).

As described above, also in this embodiment, the same effects as those in the embodiment explained with FIG. 1 to FIG. 5 described above can be obtained. Moreover, in this embodiment, no reset discharge occurs in cells which are not selected in the address period ADR of the subfield SF1. Therefore, the luminance of a visible light that is unnecessary for displaying an image emitted by a discharge in the reset period RST can be made lower as compared to the embodiment explained with FIG. 1 to FIG. 5. For example, in this embodiment, luminance when expressing using the subfield SF (subfield SF1) for low luminance and the subsequent subfield SF (subfield SF2) can be lowered. As a result, in this embodiment, the luminance when reproducing black (black luminance) can be made lower as compared to the embodiment explained with FIG. 1 to FIG. 5, and image quality when displaying a low luminance image can be improved further.

Note that the above-described embodiments have been described with respect to an example in which one pixel is made up of three cells (red (R), green (G), blue (B)). The present invention is not limited to such embodiments. For example, one pixel may be formed of four or more cells. Alternatively, one pixel may be formed of cells producing colors other than red (R), green (G), blue (B), and one pixel may include a cell producing a color other than red (R), green (G), blue (B).

The above-described embodiments have been described with respect to an example in which the address electrodes AE are provided on the glass base RS of the back plate part 14. The present invention is not limited to such embodiments. For example, the address electrodes AE may be provided on the glass base FS (between the dielectric layer DL1 and the protective layer PL shown in FIG. 2 described above) of the front plate part 12. That is, the present invention may be applied to a PDP in which three types of electrodes of sustain electrodes XE, scan electrodes YE and address electrodes AE are disposed on a front glass base FS. Also in this case, the same effects as those in the above-described embodiments can be obtained.

The above-described embodiments have been described with respect to an example in which the second direction D2 is orthogonal to the first direction D1. The present invention is not limited to such embodiments. For example, the second direction D2 may intersect the first direction D1 in a substantially orthogonal direction (for example, 90 degrees±5 degrees). Also in this case, the same effects as those in the above-described embodiments can be obtained.

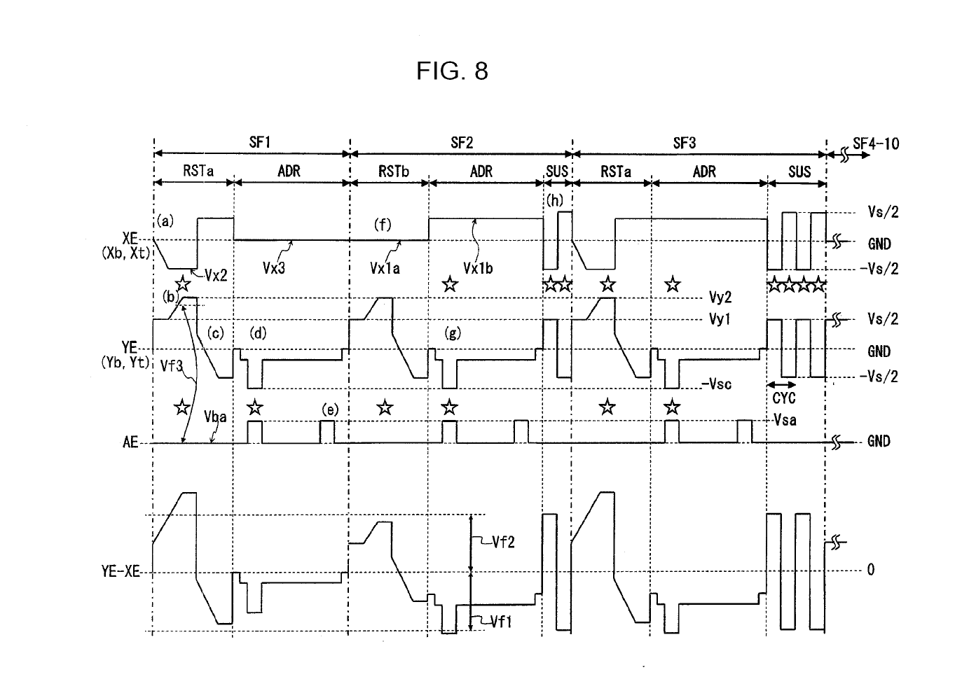

The above-described embodiments have been described with respect to an example in which the same voltage Vx1 is applied to the sustain electrode XE in the reset period RSTb and the address period ADR of the subfield SF2. The present invention is not limited to such embodiments. For example, as shown in FIG. 8, a voltage Vx1a and a voltage Vx1b different from each other may be applied to the sustain electrode XE in the reset period RSTb and the address period ADR, respectively. Also in this case, the same effects as those in the above-described embodiments can be obtained.

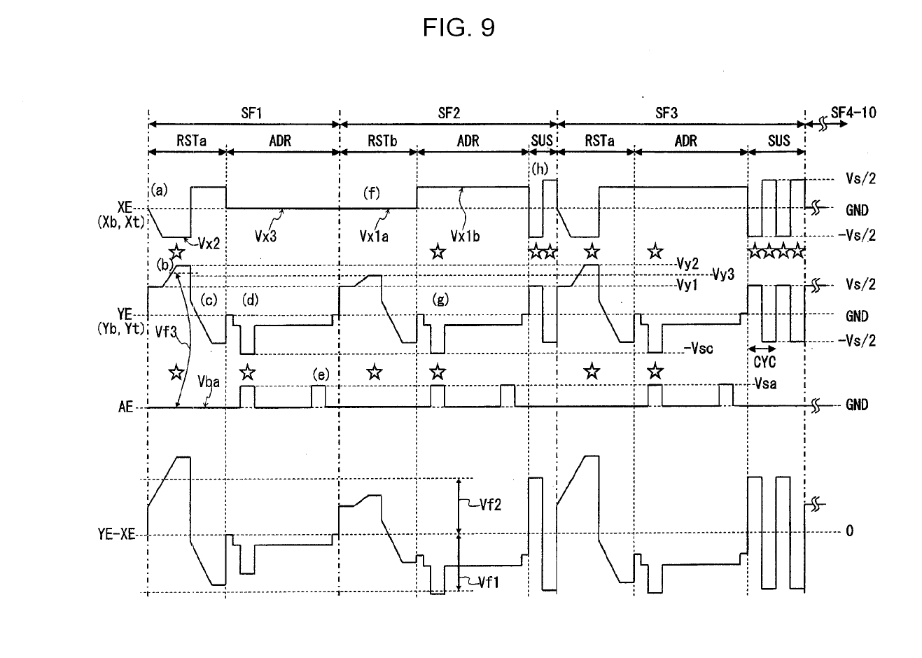

In operational waveforms shown in FIG. 8 and FIG. 9, the voltage Vx1a (first control voltage) is applied in the reset period RSTb (two-electrode reset period RSTb) of the subfield SF2, instead of the voltage Vx1 shown in FIG. 4 and FIG. 7 described above. The other operational waveforms of FIG. 8 are the same as those in FIG. 4, and the other operational waveforms of FIG. 9 are the same as those in FIG. 7. Star symbols in the diagrams have the same meaning as in FIG. 4. Here, the voltage Vx1a is a voltage which causes the voltage between the scan electrode YE and the sustain electrode XE to be smaller than the firing voltage Vf2, and is the voltage (0 V) of the ground line GND, for example. Incidentally, the voltage Vx1a may either be a positive voltage or a negative voltage as long as it can cause the voltage between the scan electrode YE and the sustain electrode XE to be smaller than the firing voltage Vf2.

Also in this case, the voltage between the scan electrode YE and the sustain electrode XE is smaller than the firing voltage Vf2, and thus no discharge occurs between the scan electrode YE and the sustain electrode XE. Incidentally, the voltage Vx1b applied to the sustain electrode XE in the address period ADR of the subfields SF2-SF10 is a voltage which causes the voltage between the scan electrode YE and the sustain electrode XE to be larger than the firing voltage Vf1 when the voltage −Vsc is applied to the scan electrode YE. For example, the voltage Vx1b is the same voltage as the voltage Vx1 shown in FIG. 4 described above. Using the operational waveforms shown in FIG. 8 and FIG. 9, the same effects as those in the embodiments shown in FIG. 4 and FIG. 7 described above can be obtained.

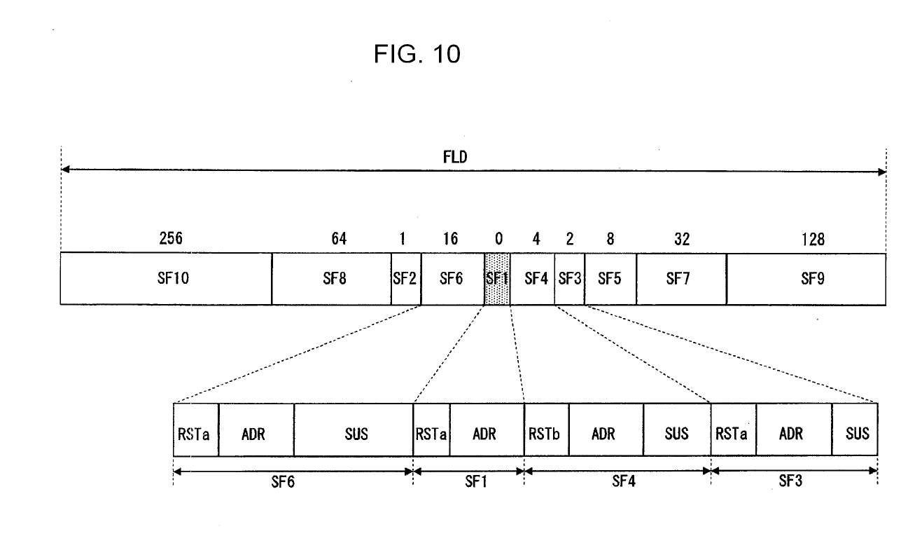

The above-described embodiments have been described with respect to an example in which the present invention is applied to the plasma display panel in which one field FLD is made up of 10 subfields SF1-SF10. The present invention is not limited to such embodiments. For example, the present invention may be applied to a plasma display panel in which one field FLD is made up of 8 subfields or 11 or more subfields. Further, the number of discharge cycles of a subfield is not limited to two to the power of n (n=integer of 0 (zero) or more). Furthermore, the subfields SF1-SF10 (FIG. 3) in the field FLD is not necessarily be arranged sequentially. For example, as shown in FIG. 10, a subfield SF1 may be arranged in the vicinity of the middle of the field FLD.

FIG. 10 shows an example in which a subfield SF1 for low luminance is arranged in the vicinity of the middle of the field FLD. The hatched portion in FIG. 10 indicates a subfield SF for low luminance. In this example, the subfield SF4 is a subfield SF subsequent to the subfield SF1 for low luminance, and thus the reset period RSTb of the subfield SF4 is the two-electrode reset period RSTb. That is, the subfields SF1-SF3, SF5-SF10 are the other subfields SF. A discharge operation in the reset period RSTb of the subfield SF4 is the same as that in the reset period RSTb of the subfield SF2 shown in FIG. 4 described above. Further, a discharge operation in the reset period RST of the subfield SF2 is the same as that in the reset period RSTa of the subfields SF1, SF3-SF10 shown in FIG. 4 described above. The other discharge operations are the same as those in FIG. 4 described above. Also in this case, the same effects as those in the above-described embodiments can be obtained.

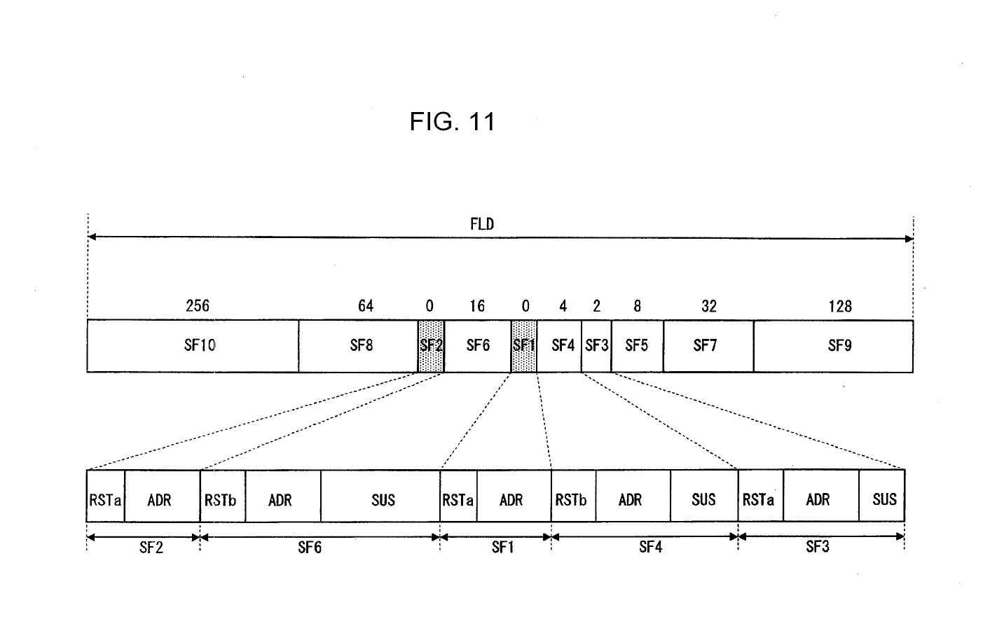

The above-described embodiments have been described with respect to an example in which one subfield SF for low luminance is provided in one field FLD. The present invention is not limited to such embodiments. For example, as shown in FIG. 11, two subfields for low luminance may be provided in one field FLD. Alternatively, three or more subfields for low luminance may be provided in one field FLD.

FIG. 11 shows an example in which two subfields SF for low luminance are arranged in one field FLD. The hatched portions in FIG. 11 indicate subfields SF for low luminance. In this example, the subfields SF1 and SF2 are subfields SF for low luminance. The subfields SF4 and SF6 are subfields SF subsequent to the subfields SF1 and SF2 for low luminance. Therefore, the reset periods RSTb of the subfields SF4 and SF6 are two-electrode reset periods RSTb. That is, the subfields SF1-SF3, SF5, SF7-SF10 are the other subfields SF. Also in this case, the same effects as those in the above-described embodiments can be obtained.

A discharge operation in the reset periods RSTb of the subfields SF4 and SF6 shown in FIG. 11 is the same as that in the reset period RSTb of the subfield SF2 shown in FIG. 4 described above. Further, a discharge operation in the reset period RSTa of the subfield SF2 is the same as that in the reset period RSTa of the subfield SF1 shown in FIG. 4 described above. Incidentally, a discharge operation in the address period ADR of the subfield SF2 is the same as that in the address period ADR of the subfield SF1 shown in FIG. 4 except the voltage value between the scan electrode YE and the address electrode AE, for example. The other discharge operations are the same as those in FIG. 4 described above.

For example, the high level voltage of an address pulse applied to the address electrode AE in the address period ADR of the subfield SF2 for low luminance is set lower than the voltage Vsa. Accordingly, the intensity of an address discharge in the subfield SF2 for low luminance becomes lower as compared to the intensity of an address discharge in the subfield SF1 for low luminance. Therefore, the luminance of a visible light emitted by the address discharge in the subfield SF2 for low luminance can be made lower as compared to the luminance of a visible light emitted by the address discharge in the subfield SF1 for low luminance. As a result, the number of gradations of a low luminance image can be increased, and the image quality can be improved.

Note that the high level voltage of an address pulse applied to the address electrode AE in the address period ADR of the subfield SF2 for low luminance may be set higher than the voltage Vsa. In this case, the luminance of a visible light emitted by the address discharge in the subfield SF2 for low luminance can be made higher as compared to the luminance of a visible light emitted by the address discharge in the subfield SF1 for low luminance. Also in this case, the same effects as those in the above-described embodiments can be obtained.

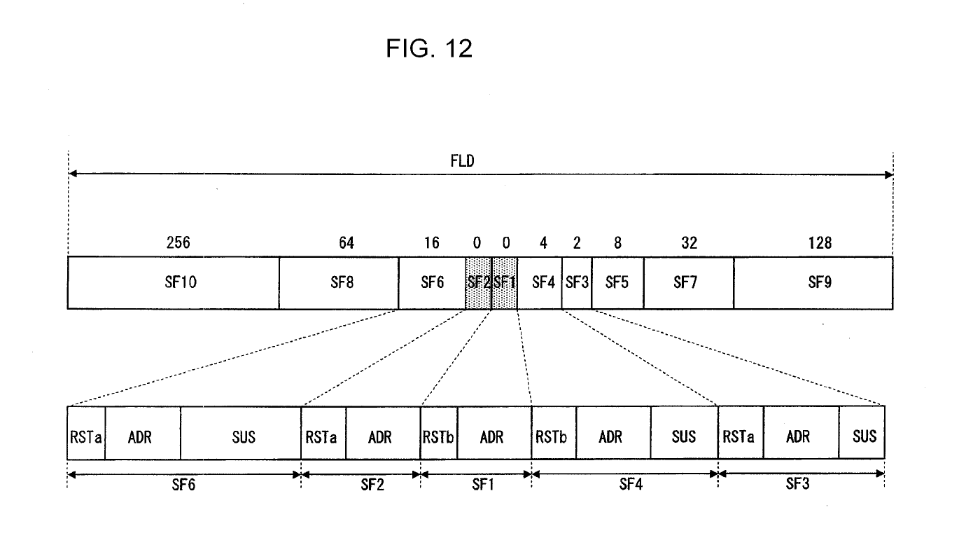

Further, as shown in FIG. 12, subfields SF1, SF2 for low luminance may be arranged in series. The hatched portions in FIG. 12 indicate subfields SF for low luminance. In this example, the subfields SF1 and SF2 are subfields SF for low luminance. The subfields SF1 and SF4 are subfields SF subsequent to the subfields SF2 and SF1 for low luminance. That is, the subfield SF1 is a subfield SF for low luminance and is a subfield SF subsequent to the subfield SF for low luminance. Therefore, the reset periods RSTb of the subfields SF1 and SF4 are two-electrode reset periods RSTb. That is, the subfields SF2, SF3, SF5-SF10 are the other subfields SF. Also in this case, the same effects as those in the above-described embodiments can be obtained.

A discharge operation in the reset period RSTb of the subfields SF1 and SF4 shown in FIG. 12 are the same as that in the reset period RSTb of the subfield SF2 shown in FIG. 4 described above. Further, a discharge operation in the reset period RSTa of the subfield SF2 is the same as that in the reset period RSTa of the subfield SF1 shown in FIG. 4 described above. Incidentally, a discharge operation in the address period ADR of the subfield SF2 is the same as that in the address period ADR of the subfield SF1 shown in FIG. 4 except the voltage value between the scan electrode YE and the address electrode AE, for example. The other discharge operations are the same as those in FIG. 4 described above.

For example, the high level voltage of an address pulse applied to the address electrode AE in the address period ADR of the subfield SF2 for low luminance is set to a voltage different from the voltage Vsa as explained with FIG. 11 described above. Accordingly, the number of gradations of a low luminance image can be increased, and the image quality can be improved.

The above-described embodiments have been described with respect to an example in which a cell to be lighted is selected by a negative scan pulse and a positive address pulse. The present invention is not limited to such embodiments. For example, in the address period ADR, a cell to be lighted may be selected by applying a positive scan pulse and a negative address pulse to the scan electrode YE and the address electrode AE, respectively. In this case, for example, respective voltages with polarities reverse to those of the respective voltages shown in FIG. 4 are applied respectively to the electrodes XE, YE, AE. Also in this case, the same effects as those in the above-described embodiments can be obtained.

The above-described embodiments have been described with respect to an example in which the firing voltage when no wall charge is stored in the electrodes XE, YE, AE is used as the firing voltages Vf1, Vf2, Vf3. The present invention is not limited to such embodiments. For example, firing voltages in a state after a predetermined reset waveform voltage (equivalent to the voltage waveform of the reset period RSTa shown in FIG. 4 described above) is applied to the electrodes XE, YE, AE may be used as the firing voltages Vf1, Vf2, Vf3. Further, the firing voltages Vf1, Vf2, Vf3 may be a firing voltage of one representative cell, or may be the average value, the maximum value, or the minimum value of firing voltages of plural cells. Also in this case, the same effects as those in the above-described embodiments can be obtained.

The above-described embodiment explained with FIG. 6 and FIG. 7 have been described with respect to an example in which all of the three-electrode reset periods RSTa are the all cell reset period. The present invention is not limited to such embodiments. For example, among the three-electrode reset periods RSTa (the reset period RSTa of the subfields SF1, SF3-SF10), only the reset period RSTa of the subfield SF1 may be the all-cell reset period. That is, at least one of the three-electrode reset periods RSTa may be the all cell reset period. In this case, the reset periods RST (reset periods RST of the subfields SF2-SF10) except the reset period RSTa (all cell reset period) of the subfield SF1 are on cell reset periods.

For example, in the reset periods RST of the subfields SF3-SF10, the positive write voltage increasing gradually from the voltage Vy1 to the voltage Vy3, the negative voltage and the voltage Vba shown in FIG. 7 described above are applied to the scan electrode YE, the sustain electrode XE and the address electrode AE, respectively. Here, the negative voltage is a voltage that causes the voltage between the scan electrode YE and the sustain electrode XE to be lower than the firing voltage Vf2. Further, the subfield SF2 is the same as that in FIG. 7 described above. Incidentally, the voltage Vy3 is a voltage which is lower than the voltage Vy2 and causes the voltage between the scan electrode YE and the address electrode AE to be lower than the firing voltage Vf3.

In this case, in the subfields SF2-SF10, a reset discharge occurs only in a cell selected in the address period ADR of the previous subfield SF. In other words, no reset discharge occurs in a cell that is not selected in the address period ADR of the previous subfield SF. Therefore, the luminance of a visible light unnecessary for displaying an image emitted by a discharge in the reset period RST can be made lower as compared to the embodiment explained with FIG. 6 and FIG. 7. As a result, in this embodiment, the luminance when reproducing black (black luminance) can be made lower as compared to the above-described embodiment, and image quality when displaying a low luminance image can be improved further.

In the foregoing, the present invention has been described in detail. However, the above-described embodiments and modification examples thereof are merely examples of the invention, and the invention is not limited thereto. It is clear that the present invention can be modified within the range not departing from the present invention.

### INDUSTRIAL APPLICABILITY

The present invention can be applied to a method of driving a plasma display panel and a plasma display device.

1. A method of driving a plasma display panel having a sustain electrode, a scan electrode and an address electrode, and a plurality of cells which emit a light by a discharge, in which one field for displaying one screen has a plurality of subfields with number of times of sustain discharge to be generated between the scan electrode and the sustain electrode being set to different values, and the subfields include a reset period to generate a reset discharge for charge adjustment in the sustain electrode, the scan electrode and the address electrode, and an address period provided after the reset period to selectively generate an address discharge between the scan electrode and the address electrode, wherein:
at least one of the plurality of subfields is a subfield for low luminance with the number of times of the sustain discharge being set to 0 (zero) and a voltage between the scan electrode and the sustain electrode during the address period being set smaller than a first firing voltage which is a firing voltage between the scan electrode and the sustain electrode; and
among the reset periods of the plurality of subfields, a reset period of a subfield subsequent to the subfield for low luminance is a first reset period to generate the reset discharge between the scan electrode and the address electrode, and reset periods of other subfields are a second reset period to generate the reset discharge between the scan electrode and the address electrode and between the scan electrode and the sustain electrode, the method comprising
applying between the scan electrode and the sustain electrode a voltage smaller than a second firing voltage which is a firing voltage between the scan electrode and the sustain electrode, in the first reset period.

2. The method of driving the plasma display panel according to claim 1, further comprising:
applying a waveform voltage which gradually increases to the scan electrode and applying a bias voltage lower than a maximum voltage of the waveform voltage to the address electrode for generating the reset discharge in the reset periods;
applying a first control voltage to the sustain electrode so that a voltage between the scan electrode and the sustain electrode is smaller than the second firing voltage when the waveform voltage is applied to the scan electrode in the first reset period;
applying a second control voltage lower than the first control voltage to the sustain electrode when the waveform voltage is applied to the scan electrode in the second reset period; and
applying a negative scan pulse and a positive address pulse to the scan electrode and the address electrode respectively so as to selectively generate the address discharge in the address period.

3. The method of driving the plasma display panel according to claim 2, wherein:
the bias voltage applied to the address electrode in the reset periods is set equal to or higher than a voltage of a ground line;
the maximum voltage of the waveform voltage applied to the scan electrode in the reset periods is set to a first voltage;
the first control voltage applied to the sustain electrode in the first reset period is set lower than the maximum voltage of the waveform voltage and equal to or higher than the voltage of the ground line; and
the first voltage is a voltage which causes a voltage between the scan electrode and the address electrode to be equal to or higher than a third firing voltage which is a firing voltage between the scan electrode and the address electrode when the bias voltage is applied to the address electrode.

4. The method of driving the plasma display panel according to claim 3, further comprising:
applying a third control voltage lower than the first control voltage to the sustain electrode in the address period in the subfield for low luminance; and
applying the first control voltage to the sustain electrode in the address period in the subfields except the subfield for low luminance, wherein
the first control voltage is a voltage which causes the voltage between the scan electrode and the sustain electrode to be equal to or higher than the first firing voltage when the negative scan pulse is applied to the scan electrode.

5. The method of driving the plasma display panel according to claim 2, wherein:
at least one of the second reset periods is an all cell reset period to generate the reset discharge between the scan electrode and the address electrode of all the cells;
the maximum voltage of the waveform voltage applied to the scan electrode in the all cell reset period is set to a first voltage;
the maximum voltage of the waveform voltage applied to the scan electrode in the reset periods except the all cell reset period is set to a second voltage lower than the first voltage; and
the first voltage is a voltage which causes a voltage between the scan electrode and the address electrode to be equal to or higher than a third firing voltage which is a firing voltage between the scan electrode and the address electrode when the bias voltage is applied to the address electrode.

6. A method of driving a plasma display panel having a plurality of sustain electrodes and scan electrodes and address electrodes disposed to intersect the sustain electrodes and the scan electrodes, in which
one field for displaying one screen has a plurality of subfields with number of times of sustain discharge to be generated between the scan electrodes and the sustain electrodes being set to different values, and
the subfields include a reset period to generate a reset discharge for charge adjustment in the sustain electrodes, the scan electrodes and the address electrodes, and an address period in which a scan pulse is applied to the scan electrodes and an address pulse is applied to the address electrodes so as to select a cell to be lighted, wherein:
at least one of the subfields is a first subfield with the number of times of the sustain discharge being 0 (zero) and a voltage difference between the scan electrodes and the sustain electrodes during the address period of the subfield being set smaller than a firing voltage between the scan electrodes and the sustain electrodes, the method comprising:
applying between the scan electrodes and the address electrodes a voltage larger than a firing voltage between the scan electrodes and the address electrodes and applying between the scan electrodes and the sustain electrodes a voltage smaller than the firing voltage between the scan electrodes and the sustain electrodes in the reset period of a second subfield subsequent to the first subfield; and
applying between the scan electrodes and the address electrodes a voltage larger than the firing voltage between the scan electrodes and the address electrodes and applying between the scan electrodes and the sustain electrodes a voltage larger than the firing voltage between the scan electrodes and the sustain electrodes in the reset periods of subfields other than the second subfield.

7. A plasma display device comprising a plasma display panel having a sustain electrode, a scan electrode, an address electrode and a plurality of cells which emit a light by a discharge, and a driver unit driving the plasma display panel, wherein:
one field for displaying one screen has a plurality of subfields with number of times of sustain discharge to be generated between the scan electrode and the sustain electrode being set to different values;
the subfields include a reset period to generate a reset discharge for charge adjustment in the sustain electrode, the scan electrode and the address electrode, and an address period provided after the reset period to selectively generate an address discharge between the scan electrode and the address electrode;
at least one of the plurality of subfields is a subfield for low luminance with the number of times of the sustain discharge being set to 0 (zero) and a voltage between the scan electrode and the sustain electrode during the address period being set smaller than a first firing voltage which is a firing voltage between the scan electrode and the sustain electrode;
among the reset periods of the plurality of subfields, a reset period of a subfield subsequent to the subfield for low luminance is a first reset period to generate the reset discharge between the scan electrode and the address electrode, and reset periods of other subfields are a second reset period to generate the reset discharge between the scan electrode and the address electrode and between the scan electrode and the sustain electrode; and
in the first reset period, the driver unit applies between the scan electrode and the sustain electrode a voltage smaller than a second firing voltage which is a firing voltage between the scan electrode and the sustain electrode.

8. The plasma display device according to claim 7, wherein
the driver unit comprises:
a scan electrode driver circuit applying a waveform voltage which gradually increases to the scan electrode in the reset periods and an address electrode driver circuit applying a bias voltage lower than a maximum voltage of the waveform voltage to the address electrode when the waveform voltage is applied to the scan electrode; and
a sustain electrode driver circuit applying a first control voltage to the sustain electrode in the first reset period among the reset periods so that a voltage between the scan electrode and the sustain electrode is smaller than the second firing voltage when the waveform voltage is applied to the scan electrode, and applying a second control voltage lower than the first control voltage to the sustain electrode in the second reset period when the waveform voltage is applied to the scan electrode, wherein:
the scan electrode driver circuit selectively applies a negative scan pulse to the scan electrode in the address period; and
the address electrode driver circuit selectively applies a positive address pulse to the address electrode in the address period.

9. The plasma display device according to claim 8, wherein
the driver unit comprises:
a bias voltage generating unit generating the bias voltage applied to the address electrode in the reset period to be equal to or higher than a voltage of a ground line;
a first voltage generating unit generating a first voltage as the maximum voltage of the waveform voltage applied to the scan electrode in the reset period; and
a first control voltage generating unit generating the first control voltage applied to the sustain electrode in the first reset period to be lower than the maximum voltage of the waveform voltage and equal to or higher than the voltage of the ground line, wherein
the first voltage generated by the first voltage generating unit is a voltage which causes a voltage between the scan electrode and the address electrode to be equal to or higher than a third firing voltage which is a firing voltage between the scan electrode and the address electrode when the bias voltage is applied to the address electrode.

10. The plasma display device according to claim 9, wherein:
the driver unit comprises a third control voltage generating unit generating a third control voltage lower than the first control voltage;
the sustain electrode driver circuit applies the third control voltage to the sustain electrode in the subfield for low luminance and applies the first control voltage to the sustain electrode in the subfields except the subfield for low luminance in the address period; and
the first control voltage generated by the first control voltage generating unit is a voltage which causes the voltage between the scan electrode and the sustain electrode to be equal to or higher than the first firing voltage when the negative scan pulse is applied to the scan electrode.

11. The plasma display device according to claim 8, wherein:
at least one of the second reset periods is an all cell reset period to generate the reset discharge between the scan electrode and the address electrode of all the cells; and
the driver unit comprises:
a first voltage generating unit generating a first voltage as the maximum voltage of the waveform voltage applied to the scan electrode in the all cell reset period; and
a second voltage generating unit generating a second voltage lower than the first voltage as the maximum voltage of the waveform voltage applied to the scan electrode in the reset periods except the all cell reset period, wherein
the first voltage generated by the first voltage generating unit is a voltage which causes a voltage between the scan electrode and the address electrode to be equal to or higher than a third firing voltage which is a firing voltage between the scan electrode and the address electrode when the bias voltage is applied to the address electrode.
